(19) United States
(12) Patent Application Publication
(10) Pub. No.: US 2022/0365245 A1
(43) Pub. Date: Nov. 17, 2022

(54) OUTPUT METHOD FOR ELECTRONIC WBGT METER, AND ELECTRONIC WBGT METER

(71) Applicant: KYOTO ELECTRONICS MANUFACTURING CO., LTD., Kyoto-shi, Kyoto (JP)

(72) Inventor: Kiyotsugu KANO, Kyoto-shi (JP)

(73) Assignee: KYOTO ELECTRONICS MANUFACTURING CO., LTD., Kyoto-shi, Kyoto (JP)

(21) Appl. No.: 17/761,851

(22) PCT Filed: Sep. 24, 2020
(86) PCT No.: PCT/JP2020/035954

§ 371 Date: Mar. 18, 2022

(30) Foreign Application Priority Data
Oct. 1, 2019 (JP) 2019-181363

(51) Int. Cl. G01W 1/17; G01W 1/02

(52) U.S. Cl. CPC G01W 1/17; G01W 1/02

(57) ABSTRACT

An electronic WBGT meter obtains a WBGT index reflecting wind velocity and radiation. A first calculation unit obtains an arbitrary-diameter globe temperature of the electronic WBGT meter with respect to each of specific thermal environments, and a second calculation unit obtains a standard-diameter globe temperature of ISO-compliant WBGT meter with respect to each of the specific thermal environments. A third calculation unit obtains a natural wet-bulb temperature with respect to each of the specific thermal environments. A correlation determination unit determines a correlation of the air temperature, the arbitrary-diameter globe temperature, and the relative humidity with corresponding the standard-diameter globe temperature and the natural wet-bulb temperature. A measurement calculation element storing the correlations is mounted in the electronic WBGT meter under a real thermal environment, and calculates the standard-diameter globe temperature and the natural wet-bulb temperature of ISO-compliant WBGT meter.

### TECHNICAL FIELD

The present invention relates to electronic WBGT meters and output methods of the electronic WBGT meters, and in particular, relate to the electronic WBGT meter and the output method of the electronic WBGT meter for obtaining a WBGT index reflecting a wind velocity and an average radiation temperature.

### BACKGROUND ART

There is the WBGT index as an index evaluating the thermal environment. Where the index value exceeds a specific value, the risk of heatstroke increases. The calculation of the WBGT index uses an air temperature ta (a dry-bulb temperature), a natural wet-bulb temperature tw, and a standard-diameter (150 mm) globe temperature tg, which are obtained by the ISO-compliant WBGT meter. The WBGT index is obtained by following two types of equations depending on the influence of the solar radiation.

Where there is the influence of the solar radiation:

WBGT=0.7×tw+0.2×tg+0.1×ta (10)

Where there is no influence of the solar radiation:

WBGT=0.7×tw+0.3×tg (11)

The ISO-compliant WBGT meter is provided with a wet-bulb thermometer, a globe thermometer with a standard-diameter globe, and a dry-bulb thermometer (a thermometer) for the above calculation, and it is configured to measure each temperature.

Meanwhile, the ISO-compliant WBGT meter becomes expensive because of using a standard-diameter globe in 150 mm and the wet-bulb thermometer. In addition, the wet-bulb thermometer is not easy to be handled because of hydration. Therefore, electronic WBGT meters capable of measuring the WBGT index in a simple way have been developed, for the physical activities and workings under the thermal environment (the heat environment, particularly).

The electronic WBGT meter, in place of the wet-bulb thermometer employed by the ISO-compliant WBGT meter, uses an electronic type of relative humidity sensor disclosed in the Japanese Unexamined Patent Application Publication No. 2011-192247, and calculates a natural wet-bulb temperature on the basis of a relative humidity and an air temperature. Since the standard-diameter globe in 150 mm has no portability, it is configured that the air temperature obtained by an arbitrary small diameter globe is converted to the temperature of the standard-diameter globe, as disclosed in the Japanese Patent No. 3556192.

### CITATION LIST

### Patent Literature

Patent Literature 1: Japanese Patent No. 3556192

Patent Literature 2: Japanese Unexamined Patent Application Publication No. 2011-192247

### SUMMARY OF INVENTION

### Technical Problem

The definition of the natural wet-bulb temperature has been transformed since the beginning of the establishment of the ISO standard for WBGT meters (1982) to the present. Namely, at the beginning of developing the electronic WBGT meter (in the 1980s), the term of the natural wet-bulb temperature was understood almost as “the temperature of the wet-bulb under the natural convection”. Here, the natural convection indicates a condition of the windless or the breeze.

According to ISO 7243 in 1989, the wet-bulb temperature was defined as “a wet-bulb temperature in the natural ventilation”, and took the wind influence in the forced convection into consideration in the same manner as in the windless or the breeze.

The ISO 7243 was revised moreover in 2017, the natural wet-bulb temperature was defined as “the wet-bulb temperature exposed to the natural environment”. The meaning of “exposed to the natural environment” is to consider the influence of the wind velocity and the radiation.

Since the above-mentioned electronic WBGT meter is not provided with an anemometer, in order to calculate the WBGT index, it is necessary for obtaining the natural wet-bulb temperature based on an assumed wind velocity in case of any generations. In addition, since the electronic WBGT meter uses a globe in an arbitrary-diameter smaller than the standard-diameter (150 mm), the arbitrary-diameter globe temperature is necessary to be converted to the standard-diameter globe temperature. At this conversion, the information of the wind velocity is required as described hereinafter, and the equation conventionally uses the assumed wind velocity in this case.

Therefore, the difference between the assumed wind velocity and the real wind velocity appears as an error in the globe temperature and the natural wet-bulb temperature. Additionally, ISO 7243 in 2017 includes that the natural wet-bulb temperature reflects the radiation influence, but the electronic WBGT meter that achieved such subject has not been realized.

In order to comply with the revised ISO, it is possible to suggest a configuration to mount the anemometer on the electronic WBGT meter. In such case, it is needless to say that a cost demerit is generated, and there are problems that the anemometer requires a special calibration equipment and it is fragile.

The present invention is proposed in view of the above problems in the conventional art, and has an object to provide an electronic WBGT meter for obtaining the WBGT index reflecting wind velocity and radiation.

### Solution to Problem

In order to resolve the above subject, the present invention has following means.

First, a first calculation unit changes an air temperature, an average radiation temperature, and a wind velocity, and calculates an arbitrary-diameter globe temperature of an electronic WBGT meter with respect to each condition, by a theoretical equation.

Next, a second calculation unit changes an air temperature, an average radiation temperature, and a wind velocity, and calculates a standard-diameter globe temperature of an ISO-compliant WBGT meter with respect to each condition, by another theoretical equation.

Further, a third calculation unit changes an air temperature, an average radiation temperature, a wind velocity, and a relative humidity, and calculates a natural wet-bulb temperature with respect to each condition, by the other theoretical equation.

A correlation determination unit determines a correlation between input and output, based on an input data group for inputting the air temperature, the arbitrary-diameter globe temperature and the relative humidity with respect to each of the specific thermal environments, and an output data group for outputting the standard-diameter globe temperature and the natural wet-bulb temperature corresponding thereto.

The correlation determination unit determines the correlation by learning the input and output data groups, and determines an equation indicating the correlation between the input and output data groups.

The correlation determined as above is stored in a measurement calculation element for calculating the standard-diameter globe temperature and the natural wet-bulb temperature of the ISO-compliant WBGT meter based on the arbitrary-diameter globe temperature, the relative humidity and the air temperature of the electronic WBGT meter, and the measurement calculation element is installed in the electronic WBGT meter in accordance with the present invention that is placed in a real thermal environment. Therefore, the combination of means before the correlation is determined by the measurement calculation element can be realized by another device separated from the electronic WBGT meter as an association device (or, procedure).

The present invention can be also realized by a process invention for obtaining the output of the ISO-compliant WBGT meter using the electronic WBGT meter.

### Advantageous Effects of Invention

As described above, it is possible to obtain the standard-diameter globe temperature and the natural wet-bulb temperature, that reflect the wind velocity and the average radiation temperature, by the electronic WBGT meter without the aerometer. The WBGT index obtained based on the equations (10) and (11) also reflects the wind velocity and the average radiation temperature.

### BRIEF DESCRIPTION OF DRAWINGS

FIG. 1 is a schematic view showing an outline of the present invention; and,

FIG. 2 is a block diagram of the present invention.

### DESCRIPTION OF EMBODIMENTS

### <Principle>

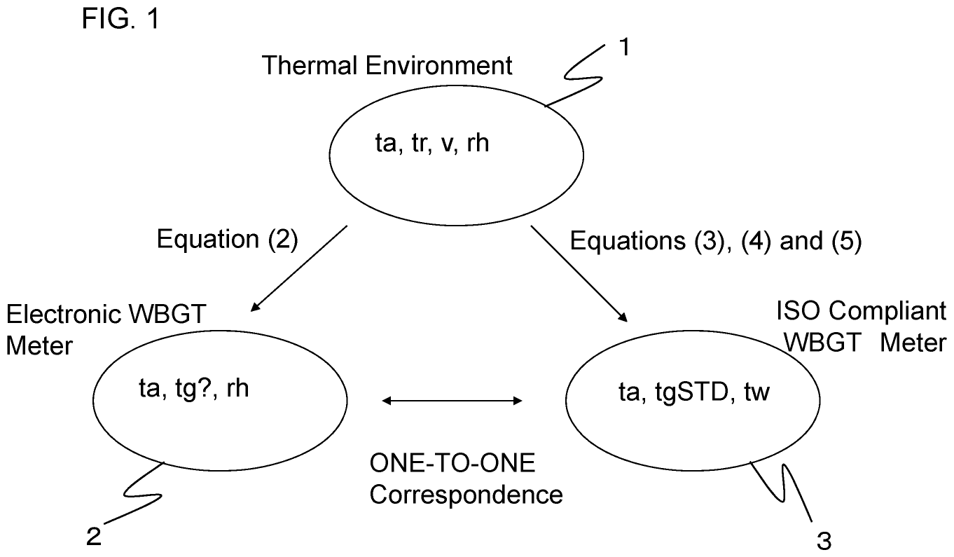

FIG. 1 is a diagram showing a basic concept of the present invention. An arbitrary-diameter globe temperature tg? indicated by the electronic WBGT meter 2 under a specific thermal environment 1 (an air temperature ta, an average radiation temperature tr, a wind velocity v, a relative humidity rh) can be calculated by Equation (2). A standard-diameter globe temperature tgSTD indicated by an ISO-compliant WBGT meter 3 under the same specific thermal environment 1 can be calculated by Equation (3). Further, a natural wet-bulb temperature tw indicated by an ISO-compliant WBGT meter 3 under the same specific thermal environment 1 can be calculated by Equations (4) and (5). Therefore, it is possible to make one-to-one correspondence between an output of the electronic WBGT meter 2 (the air temperature ta, the arbitrary-diameter globe temperature tg?, the relative humidity rh) and an output of the ISO-compliant WBGT meter 3 (the air temperature ta, the standard-diameter globe temperature tgSTD, the natural wet-bulb temperature tw), so that by obtaining the mutual correlation between them, the output of the ISO-compliant WBGT meter 3 can be obtained based on the output of the electronic WBGT meter 2.

According to Annex B in ISO7726, it is possible to calculate the average radiation temperature under the forced convection from the globe temperature by a following equation (1).

$$t r = {[ {( t g + 273 )}^{4} + \frac{1.1 \times 1 {0}^{8} \times {v}^{0.6}}{ε \times {D}^{0.4}} ( tg - ta ) ]}^{1 / 4} - 273 \qquad ( 1 )$$

In the equation (1), D is a diameter of the standard-diameter globe, and tg is a temperature of the standard-diameter globe (hereinafter referred to as tgSTD). Moreover, the above equation can be applied to an arbitrary-diameter d of the arbitrary-diameter globe, and can be converted to a following equation (2) as the thermal equilibrium equation. The thermal equilibrium equation for the standard-diameter globe is a following equation (3).

1.1×10⁸×v^{0.6}(tg?−ta)−εd^{0.4}(Tr⁴−Tg?⁴)=0 (2)

1.1×10⁸×v^{0.6}(tgSTD−ta)−ε(0.15)^{0.4}(Tr⁴−TgSTD⁴)=0 (3)

Where the air temperature ta, the average radiation temperature tr(Tr=tr+273), the wind velocity v, the globe diameter d, and the globe emissivity ε (e.g. ε=0.90) under the specific thermal environment are substituted in the equation (2), the arbitrary-diameter globe temperature tg? can be calculated. That is to say, the arbitrary-diameter globe temperature tg?(Tg?=tg?+273) can be obtained based on the air temperature ta, the average radiation temperature tr(Tr), and the wind velocity v under the specific thermal environment.

Where the air temperature ta, the average radiation temperature tr(Tr), the wind velocity v, the globe diameter D (=0.15), and the standard-diameter globe emissivity (ε=0.95) under the specific thermal environment are substituted in the equation (3), the standard-diameter globe temperature tgSTD(Tg=tgSTD+273) can be calculated. That is to say, the standard-diameter globe temperature tgSTD(TgSTD) can be obtained based on the air temperature ta, the average radiation temperature tr(Tr), and the wind velocity v under the specific thermal environment.

The thermal equilibrium equation for the natural wet-bulb temperature is a following equation (4) (ISO 7243, Annex D).

4.18v^{0.444}(Ta−Tw)+10⁸(Tr⁴−Tw⁴)−77.1v^{0.421}[Pa(tw)−rh×Pa(ta)]=0 (4)

Here, a saturated vapor pressure Pa(t) at a specific temperature (t) is calculated by a following equation (5) on the basis of Tetens Equation.

$$P a ( P ) = 6.1078 \times {10}^{\frac{7.5 t}{t + 237.3}} \qquad ( 5 )$$

Where the air temperature ta(Ta), the average radiation temperature tr(Tr), the wind velocity v, the saturated vapor pressure Pa(ta) at the air temperature ta, and a relative humidity rh, those under the specific thermal environment, are substituted in the above equation, the natural wet-bulb temperature tw(Tw) of the ISO-compliant WBGT meter can be obtained.

According to the above process, it is possible to obtain the standard-diameter globe temperature tgSTD(TgSTD) and the natural wet-bulb temperature tw(Tw) corresponding to the ISO-compliant WBGT meter that reflect the wind velocity and the average radiation temperature under the same specific thermal environment, and correspond in one-to-one to the arbitrary-diameter globe temperature tg?(Tg?) of the electronic WBGT meter. The equations (10) and (11) are calculated based on the values obtained in such way, so that it is possible to obtain an WBGT index reflecting the wind velocity and the average radiation temperature based on the output of the electronic WBGT meter.

### <Creation and Learning of Data>

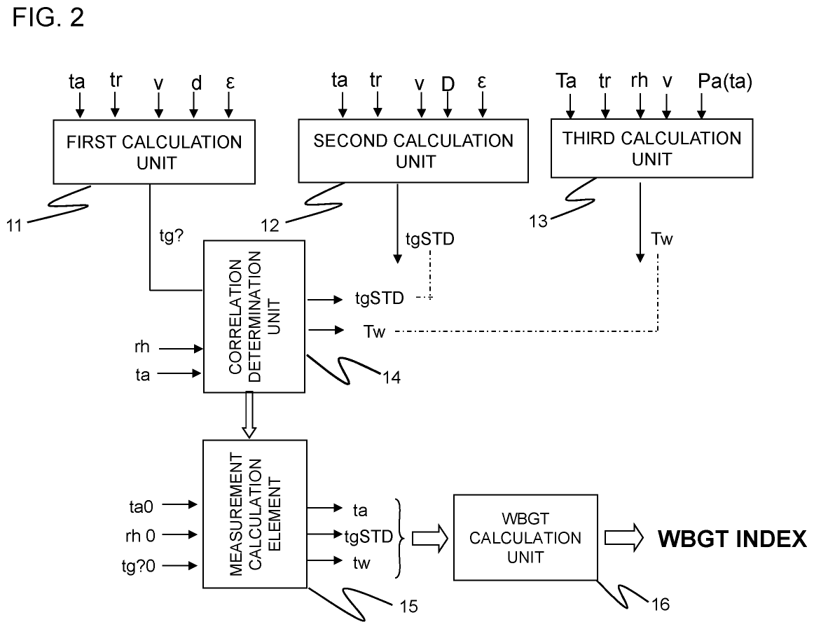

FIG. 2 is a block diagram of the present invention.

Where, according to the above process, the air temperature ta, the standard-diameter globe temperature tgSTD(TgSTD) and the natural wet-bulb temperature tw(Tw) of the ISO-compliant WBGT meter are obtained in advance, with respect to each of the specific thermal environments, together with the air temperature to and the relative humidity rh, that corresponds in one-to-one to the arbitrary-diameter globe temperature tg?(Tg?) of the electronic WBGT meter, those obtained values are available to the learning of a neural network (correlation determination unit 14) as described hereinafter.

First of all, in a first calculation unit 11, the air temperature ta, the wind velocity v, the globe emissivity e, the arbitrary globe diameter d, and the average radiation temperature Tr with respect to each of the thermal environments are substituted in the equation (2), so that the globe temperature tg? of the diameter d is obtained in advance.

Next, in a second calculation unit 12, the air temperature ta, the wind velocity v, the globe emissivity ε(=0.95), the standard globe diameter D(=0.15), and the average radiation temperature Tr with respect to each of the specific thermal environments are substituted into the equation (3), so that the standard-diameter globe temperature tgSTD is obtained in advance.

Here, since the equation (2) and the equation (3) are quartic equations of tg? or tgSTD, those values can be numerically obtained by Newton's Method.

Further, in a third calculation unit 13, the air temperature ta(Ta), the average radiation temperature Tr, the wind velocity v, the relative humidity rh, and the saturated vapor pressure Pa(ta) at the air temperature ta with respect to each of the thermal environments are substituted into the equation (4), so that the natural wet-bulb temperature Tw(tw) is obtained together with the corresponding saturated vapor pressure Pa(tw).

In the equations (4) and (5), it is possible to obtain two unknowns Tw and Pa(tw) numerically at the same time by the Fales Position Method. Otherwise, the natural wet-bulb temperature Tw(tw) can be obtained by substituting the equation (5) into the equation (4) and using the Newton Method.

And then, the neural network (a correlation determination unit 14) learns training data, wherein the arbitrary-diameter globe temperature tg?, the air temperature ta, and the relative humidity rh under each thermal environment obtained as above are set as an input, while the standard-diameter globe temperature tgSTD and the natural wet-bulb temperature tw are set as an output.

The configuration (the process) before finding the correlation between the outputs and the inputs, namely, plural units (the first calculation unit 11, the second calculation unit 12, the third calculation unit 13, and the correlation determination unit 14), can be realized as a correlation device provided separately from the following electronic WBGT meter. That is to say, in the correlation device, the correlation decided as above is stored in a measurement calculation element 15, and the measurement calculation element 15 is mounted in the electronic WBGT meter, which is applied to the calculation of the ISO-compliant WBGT index as described hereinafter.

### <The Electronic WBGT Meter>

Where the neural network learned as above is mounted in the electronic WBGT meter as the measurement calculation element 15, when the air temperature ta0, the arbitrary-diameter globe temperature tg?0, and the relative humidity rh0 under the real thermal environment are inputted therein, the standard-diameter globe temperature tgSTD and the natural wet-bulb temperature tw can be obtained in addition to the air temperature ta. Moreover, the standard-diameter globe temperature tgSTD and the natural wet-bulb temperature tw reflect the wind velocity and the average radiation temperature.

Besides, the measurement calculation element 15 is also provided with a function of the neural network, and learns based on the new data inputted therein, so that it is possible to improve the accuracy.

When the air temperature ta, the standard-diameter globe temperature tgSTD, and the natural wet-bulb temperature tw obtained as described above are inputted in a WBGT calculation unit 16, it is possible to obtain the WBGT index reflecting the wind velocity and the average radiation temperature, even though the electronic WBGT meter without the anemometer.

### <Testing>

The training data under the thermal environment is created by following process.

TABLE 1

| | | | Number of | Number |
|---|---|---|---|---|
| | Range | Resolution | divisions | of data |
| Temperature | 16~32(° C.) | 2(° C.) | 8 | 9 |
| ta | | | | |
| Wind | 0.12~3.12(m/s) | 0.1(m/s) | 30 | 31 |
| velocity v | | | | |
| Average | 20~60(° C.) | 4(° C.) | 10 | 11 |
| radiation | | | | |
| temperature | | | | |
| tr | | | | |
| Relative | 20~80(%) | 3(%) | 20 | 21 |
| humidity rh | | | | |

By multiplying the number of data in each of the above items, the total number of data is 64,449, of which 50,000 are set as leaning data and 14,449 are set as test data.

When estimating from the above 14,449 test data, using the neural network (the measurement calculation element 15) that has learned 50,000 data as the learning data, the result of the estimate errors is shown in following Table 2.

TABLE 2

| | ΔtgSTD | Δtw | ΔWBGT |
|---|---|---|---|
| Number | 14,449 | 14,449 | 14,449 |
| Average | 0.000 | 0.009 | 0.006 |
| Standard deviation | 0.232 | 0.317 | 0.228 |
| Minimum | −1.042 | −2.015 | −1.370 |
| Maximum | 1.487 | 1.092 | 0.888 |

According to the above results, it can be said that the WBGT index can be estimated in an error range of ±0.7° C. with a 99% probability under an arbitrary wind velocity.

Here, with respect to the above 14,449 data, the standard-diameter globe temperatures are calculated by the globe thermal equilibrium equation assuming the wind velocity from the arbitrary-diameter globe temperature tg?, and then, the natural wet-bulb temperatures tw are calculated based on the air temperature to and the relative humidity rh by the Ango equation. The estimate results of this conventional method is shown in below, Table 3.

TABLE 3

| | ΔtgSTD | Δtw | ΔWBGT |
|---|---|---|---|
| Number | 14,449 | 14,449 | 14,449 |
| Average | −0.292 | −0.543 | −0.467 |
| Standard deviation | 0.376 | 1.441 | 1.036 |
| Minimum | −1.079 | −10.162 | −6.583 |
| Maximum | 1.772 | 2.202 | 1.453 |

It is understood that, when the standard deviations of ΔWBGT obtained by the above conventional method are compared with the values of the method of the present invention, the error distribution has a spread of about 4.5 times of the present invention.

### EXAMPLE

According to the above description, the standard-diameter globe temperature tgSTD, the natural wet-bulb temperature tw, and the WBGT index are estimated by inputting the air temperature ta, the globe temperature tg50, and the relative humidity rh indicated by the electronic WBGT meter with the 50 mm diameter globe. The estimate values are compared with the corresponding correct values, which are shown in Table 4. Accordingly, it can be understood that the electronic WBGT meter in accordance with the present invention can obtain WBGT indices that are sufficiently put into practical use.

TABLE 4

| | | | | | | | | Unit ° C. |
|---|---|---|---|---|---|---|---|---|
| | | | Estimate_ | Estimate_ | Estimate_ | Correct_ | Correct_ | Correct_ |
| ta | tg50 | rh | tgSTD | tw | WBGT | tgSTD | tw | WBGT |
| 26 | 31.246 | 38 | 33.340 | 18.647 | 23.055 | 33.378 | 18.431 | 22.915 |
| 28 | 29.045 | 53 | 29.475 | 21.423 | 23.838 | 29.515 | 21.176 | 23.677 |
| 30 | 32.747 | 50 | 33.838 | 22.807 | 26.117 | 33.949 | 22.805 | 26.148 |
| 32 | 32.000 | 44 | 31.998 | 22.090 | 25.063 | 32.000 | 22.441 | 25.309 |
| 24 | 27.385 | 23 | 28.750 | 13.784 | 18.274 | 28.561 | 13.964 | 18.343 |
| 16 | 19.571 | 44 | 21.051 | 11.078 | 14.070 | 21.153 | 11.298 | 14.254 |
| 24 | 25.801 | 44 | 26.546 | 17.233 | 20.027 | 26.589 | 16.721 | 19.682 |
| 26 | 29.714 | 50 | 31.206 | 20.402 | 23.643 | 30.796 | 20.116 | 23.320 |
| 18 | 29.554 | 29 | 33.070 | 13.583 | 19.429 | 32.906 | 14.082 | 19.729 |
| 20 | 27.980 | 71 | 31.042 | 19.271 | 22.803 | 31.276 | 19.245 | 22.854 |
| 22 | 24.996 | 56 | 26.224 | 17.552 | 20.153 | 26.176 | 17.354 | 20.000 |
| 20 | 23.515 | 26 | 24.951 | 11.661 | 15.648 | 24.999 | 11.707 | 15.695 |
| 22 | 29.404 | 80 | 32.315 | 21.916 | 25.036 | 32.479 | 21.818 | 25.016 |
| 26 | 34.533 | 68 | 37.364 | 24.288 | 28.211 | 37.293 | 23.941 | 27.947 |
| 26 | 29.378 | 53 | 30.738 | 20.758 | 23.752 | 30.860 | 20.290 | 23.461 |
| 30 | 33.215 | 74 | 34.496 | 26.744 | 29.069 | 34.563 | 26.955 | 29.238 |
| 30 | 30.472 | 41 | 30.664 | 20.313 | 23.418 | 30.648 | 20.536 | 23.569 |
| 32 | 28.789 | 71 | 27.526 | 26.050 | 26.493 | 27.674 | 26.867 | 27.109 |

### <Curve Fitting>

The data obtained under a plurality of the specific thermal environments according to the above process, namely, the arbitrary-diameter globe temperature tg? calculated by the first calculation unit 11, the standard-diameter globe temperature tgSTD calculated by the second calculation unit 12, and the natural wet-bulb temperature tw calculated by the third calculation unit 13, can be used as the data for determining an approximate equation for the curve fitting together with the air temperature ta and the relative humidity rh.

In other words, a following approximate equation (6) is obtained by the correlation between the air temperature ta, the arbitrary-diameter globe temperature tg?, and the standard-diameter globe temperature tgSTD. And then, on the basis of the obtained data group of the air temperature ta, the arbitrary-diameter globe temperature tg?, and the standard-diameter globe temperature tgSTD, the correlation determination unit 14 can determine each coefficient of degrees. Besides, the equation is a quadratic equation of tg and tgSTD in this embodiment, however, the degree of the equation can be increased or decreased freely according to the required accuracy. In addition, the method of calculating each coefficient of degrees is well-known in public, and the explanation is not described here.

tgSTD=A·ta²+B·ta+C·tg?²+D·tg?+E·ta·tg?+Q (6)

Here, if the arbitrary diameter is 50 mm (tg50), each coefficient is determined using the 50,000 data, and the results are as follows.

A=−0.00813305888, B=−0.567951826, C=−0.0137013277, D=1.59857015, E=0.0214477372, Q=−0.487003283

In addition, the natural wet-bulb temperature tw can be obtained by a following equation (7), on the basis of the air temperature ta, the arbitrary-diameter globe temperature tg?, and the relative humidity rh.

tw=A·ta³+B·ta²+C·ta+D·tg?³+E·tg?²+F·tg?+G·rh³+H·rh²+I·rh+J·ta·tg?·rh+K·tg?·rh+L·ta·rh+M·ta·tg?+Q (7)

The correlation determination unit 14 can determine the each coefficient of degrees based on the data group of the air temperature ta, the arbitrary-diameter globe temperature tg?, the relative humidity rh, and the natural wet-bulb temperature tw, that are obtained as described above.

Here, where the arbitrary diameter is 50 mm (tg50), each coefficient is determined using the 50,000 data, and the results are as follows. In this case, it is configured to obtain the third-degree coefficient with respect to ta, tg, and rh, however, the degree of coefficient can be increased or decreased according to the conditions.

| | |
|---|---|
| A = −5.01528377 × 10⁻⁵, | B = 0.0108706541, |
| C = −0.157896135, | D = 0.000109347496, |
| E = −0.0104562755, | F = 0.889654587, |
| G = 1.60312065 × 10⁻⁶, | H = −0.00068305723, |
| I = −0.105621516, | J = 2.35596747 × 10⁻⁶, |
| K = −0.00210613502, | L = 0.00658788765, |
| M = −0.00561414292, | Q = −7.47427592 |

Where each coefficient of degree in the respective equations is determined in this way, the equations (6) and (7), of which the coefficients are determined, are stored in the measurement calculation element 15, whereby the standard-diameter globe temperature tgSTD, the natural wet-bulb temperature tw, and the air temperature to are obtained on the basis of the air temperature ta0, the relative humidity rh0, and the arbitrary-diameter globe temperature tg?0 under the real thermal environment, and the output of the ISO-compliant WBGT index is obtained by the WBGT calculation unit 16.

### <Testing>

When estimating by the above two equations using 14,449 test data, the difference between the estimation and the above correct data with respect to the standard-diameter globe temperature tgSTD and the natural wet-bulb temperature tw is shown in Table 5.

TABLE 5

| | ΔtgSTD | Δtw | ΔWBGT |
|---|---|---|---|
| Number | 14,449 | 14,449 | 14,449 |
| Average | 0.000 | −0.001 | −0.001 |
| Standard deviation | 0.232 | 0.141 | 0.105 |
| Minimum | −1.501 | −1.180 | −1.162 |
| Maximum | 1.417 | 0.527 | 0.407 |

### EXAMPLES

Table 6 shows the real air temperature ta, the globe temperature tg50, and the relative humidity rh, indicated by the electronic WBGT meter provided with the globe in 50 mm diameter; the standard-diameter globe temperature tgSTD, the natural wet-bulb temperature tw and the WBGT index that are obtained by inputting the above mentioned data into the above approximate equations; and the globe temperature tgSTD, the natural wet-bulb temperature tw, and the WBGT index indicated by the ISO-compliant WBGT meter. It is understood that it is possible to obtain values enough for practical use by the electronic WBGT meter.

TABLE 6

Unit ° C.

| | | | Estimate_ | Estimate_ | Estimate_ | correct_ | correct_ | correct_ |
|---|---|---|---|---|---|---|---|---|
| ta | tg50 | rh | tgSTD | tw | WBGT | tgSTD | tw | WBGT |
| 26 | 32.653 | 59 | 35.047 | 22.178 | 26.039 | 35.115 | 22.162 | 26.048 |
| 32 | 30.965 | 23 | 30.624 | 17.657 | 21.547 | 30.503 | 17.256 | 21.230 |
| 18 | 41.439 | 38 | 45.368 | 19.789 | 27.463 | 46.003 | 19.571 | 27.501 |
| 32 | 29.144 | 29 | 27.964 | 18.404 | 21.272 | 28.306 | 18.882 | 21.709 |
| 20 | 26.154 | 35 | 28.557 | 14.105 | 18.441 | 28.809 | 14.101 | 18.513 |
| 32 | 36.555 | 29 | 38.225 | 20.772 | 26.008 | 38.136 | 20.785 | 25.990 |
| 20 | 23.033 | 68 | 24.332 | 17.270 | 19.389 | 24.280 | 17.238 | 19.351 |
| 18 | 19.251 | 41 | 19.784 | 11.525 | 14.003 | 19.821 | 11.417 | 13.938 |
| 22 | 23.274 | 50 | 23.846 | 15.954 | 18.322 | 23.851 | 15.855 | 18.254 |
| 26 | 31.833 | 53 | 34.002 | 21.038 | 24.927 | 34.113 | 21.030 | 24.955 |
| 30 | 33.490 | 20 | 34.872 | 17.193 | 22.497 | 34.780 | 17.109 | 22.411 |
| 16 | 17.107 | 59 | 17.551 | 12.060 | 13.707 | 17.492 | 12.098 | 13.716 |
| 28 | 29.654 | 47 | 30.398 | 20.351 | 23.365 | 30.392 | 20.319 | 23.341 |
| 16 | 18.086 | 47 | 18.980 | 11.086 | 13.454 | 18.964 | 11.005 | 13.393 |
| 24 | 31.751 | 41 | 34.485 | 18.339 | 23.183 | 34.857 | 18.310 | 23.274 |
| 16 | 21.723 | 50 | 24.059 | 12.935 | 16.272 | 23.451 | 12.889 | 16.058 |
| 26 | 25.190 | 32 | 24.869 | 15.299 | 18.170 | 24.973 | 15.888 | 18.613 |
| 16 | 20.317 | 41 | 22.138 | 11.319 | 14.565 | 22.282 | 11.303 | 14.597 |

### INDUSTRIAL APPLICABILITY

As described above, the present invention allows the electronic WBGT meter without the aerometer and the wet-bulb to obtain the standard-diameter globe temperature, the natural wet-bulb temperature, and the WBGT index, those reflecting the wind velocity and the average radiation temperature. The present invention is very available with respect to the cost and the device capacity.

Besides, the first to third calculation units, the correlation determination unit, the measurement calculation element, and the WBGT calculation unit can be realized by an electronic circuit or a program working with a computer. In addition, it is general that the electronic WBGT meter is delivered in a state of mounting the measurement calculation element therein, but it is possible to deal with the measurement calculation element as one unit. The user subscribed the unit mounts it on the electronic WBGT meter by the user.

### REFERENCE SIGNS LIST

1 Thermal environment
2 Electronic WBGT meter
3 ISO-compliant WBGT meter
11 First calculation unit
12 Second calculation unit
13 Third calculation unit
14 Correlation determination unit
15 Measurement calculation element
16 WBGT calculation unit
ta: Temperature [° C.] (ta0: Real temperature)
Ta: ta+273 (absolute temperature)
v: Wind velocity [m/s]
tg: Globe temperature [° C.]
Tg: Globe absolute temperature (tg+273)
tgSTD: Globe Temperature in 150 mm diameter
tg?: Globe temperature in an arbitrary-diameter (tg?0: Real globe temperature in arbitrary-diameter)
tr: Average radiation temperature [° C.]
Tr: Absolute temperature of average radiation temperature (tr+273)
tw: Natural wet-bulb temperature
Tw: Natural wet-bulb absolute temperature (tw+273)
Pa(t): Saturated vapor pressure at temperature t
rh: Relative humidity (rh0: Real relative humidity)
d: Diameter of globe (arbitrary diameter)
D: Diameter of standard globe (standard diameter=0.15 m)
ε: Emissivity

1-17. (canceled)

18. A method for correlating measured values of an electronic WBGT meter with measured values of an ISO-compliant WBGT meter, comprising steps of:
obtaining an arbitrary-diameter globe temperature of the electronic WBGT meter with respect to each of specific thermal environments, based on air temperatures, average radiation temperatures, and wind velocities under the specific thermal environments;
obtaining a standard-diameter globe temperature of the ISO-compliant WBGT meter with respect to each of the specific thermal environments, based on the air temperatures, the average radiation temperatures, and the wind velocities under the specific thermal environments;
obtaining a natural wet-bulb temperature of the ISO-compliant WBGT meter with respect to each of the specific thermal environments, based on the air temperatures, the average radiation temperatures, the wind velocities, and relative humidities under the specific thermal environments; and
determining a correlation between input and output, based on an input data group for inputting the air temperature, the arbitrary-diameter globe temperature, and the relative humidity with respect to each of the specific thermal environments, and an output data group for outputting the standard-diameter globe temperature and the natural wet-bulb temperature corresponding thereto.

19. The method for correlating the measured values of the electronic WBGT meter with measured values of the ISO-compliant WBGT meter according to claim 18, wherein the correlation is determined by learning the input and output data groups as learning data.

20. The method for correlating the measured values of the electronic WBGT meter with measured values of the ISO-compliant WBGT meter according to claim 18, wherein the correlation is determined by obtaining an approximate equation that is completed between the input and output data groups.

21. A device for correlating measured values of an electronic WBGT meter with measured values of an ISO-compliant WBGT meter,
wherein the electronic WBGT meter includes a thermometer, an arbitrary-diameter globe temperature and a relative hygrometer,
which comprising,
a first calculation unit for obtaining an arbitrary-diameter globe temperature of the electronic WBGT meter with respect to each of specific thermal environments, based on air temperatures, average radiation temperatures, and wind velocities under the specific thermal environments;
a second calculation unit for obtaining a standard-diameter globe temperature of the ISO-compliant WBGT meter with respect to each of the specific thermal environments, based on the air temperatures, the average radiation temperatures, and the wind velocities under the specific thermal environments;
a third calculation unit for obtaining a natural wet-bulb temperature of the ISO-compliant WBGT meter with respect to each of the specific thermal environments, based on the air temperatures, the average radiation temperatures, the wind velocities, and relative humidities under the specific thermal environments; and
a correlation determination unit for determining a correlation between input and output based on an input data group for outputting the air temperature, the arbitrary-diameter globe temperature, and the relative humidity with respect to the specific thermal environments, and an output data group for outputting the standard-diameter globe temperature and the natural wet-bulb temperature corresponding thereto.

22. The device for correlating measured values of the electronic WBGT meter with measured values of the ISO-compliant WBGT meter according to claim 21, wherein the correlation determination unit determines the correlation by learning the input and output data groups as learning data.

23. The device for correlating measured values of the electronic WBGT meter with measured values of the ISO-compliant WBGT meter according to claim 21, wherein the correlation determination unit determines the correlation by obtaining an approximate equation that is completed between the input and output data groups.

24. An output method of an electronic WBGT meter comprising steps of:
obtaining an arbitrary-diameter globe temperature of the electronic WBGT meter with respect to each of specific thermal environments, based on air temperatures, average radiation temperatures, and wind velocities under the specific thermal environments;
obtaining a standard-diameter globe temperature of the ISO-compliant WBGT meter with respect to each of the specific thermal environments, based on the air temperatures, the average radiation temperatures, and the wind velocities under the specific thermal environments;
obtaining a natural wet-bulb temperature of the ISO-compliant WBGT meter with respect to each of the specific thermal environments, based on the air temperatures, the average radiation temperatures, the wind velocities, and relative humidities under the specific thermal environments;
determining a correlation between input and output, based on an input data group for inputting the air temperature, the arbitrary-diameter globe temperature, and the relative humidity with respect to each of the specific thermal environments, and an output data group for outputting the standard-diameter globe temperature and the natural wet-bulb temperature corresponding thereto; and
obtaining a standard-diameter globe temperature and a natural wet-bulb temperature of an ISO-compliant WBGT meter from a real air temperature, an arbitrary-diameter globe temperature and a relative humidity measured by the electronic WBGT meter, based on the correlation.

25. The output method of an electronic WBGT meter according to claim 24,
wherein the correlation is determined by learning the input and output data groups as learning data or
wherein the correlation is determined by obtaining an approximate equation that is completed between the input and output data groups.

26. The output method of the electronic WBGT meter comprising the steps of:
obtaining an arbitrary-diameter globe temperature of the electronic WBGT meter with respect to each of specific thermal environments, based on air temperatures, average radiation temperatures, and wind velocities under the specific thermal environments;
obtaining a standard-diameter globe temperature of the ISO-compliant WBGT meter with respect to each of the specific thermal environments, based on the air temperatures, the average radiation temperatures, and the wind velocities under the specific thermal environments;
obtaining a natural wet-bulb temperature of the ISO-compliant WBGT meter with respect to each of the specific thermal environments, based on the air temperatures, the average radiation temperatures, the wind velocities, and relative humidities under the specific thermal environments;
determining a correlation between input and output, based on an input data group for inputting the air temperature, the arbitrary-diameter globe temperature, and the relative humidity with respect to each of the specific thermal environments, and an output data group for outputting the standard-diameter globe temperature and the natural wet-bulb temperature corresponding thereto;
obtaining a standard-diameter globe temperature and a natural wet-bulb temperature of an ISO-compliant WBGT meter from a real air temperature, an arbitrary-diameter globe temperature and a relative humidity measured by the electronic WBGT meter, based on the correlation; and
calculating a WBGT index from the real air temperature, and the standard-globe temperature and the natural wet-bulb temperature of the ISO-compliant WBGT meter.

27. The output method of the electronic WBGT meter according to claim 26,
wherein the correlation is determined by learning the input and output data groups as learning data or
wherein the correlation is determined by obtaining an approximate equation that is completed between the input and output data groups.

28. An electronic WBGT meter including a thermometer, an arbitrary-diameter globe temperature and a relative hygrometer, which comprising,
a first calculation unit for obtaining an arbitrary-diameter globe temperature of the electronic WBGT meter with respect to each of specific thermal environments, based on air temperatures, average radiation temperatures, and wind velocities under the specific thermal environments;
a second calculation unit for obtaining a standard-diameter globe temperature of the ISO-compliant WBGT meter with respect to each of the specific thermal environments, based on the air temperatures, the average radiation temperatures, and the wind velocities under the specific thermal environments;
a third calculation unit for obtaining a natural wet-bulb temperature of the ISO-compliant WBGT meter with respect to each of the specific thermal environments, based on the air temperatures, the average radiation temperatures, the wind velocities, and relative humidities under the specific thermal environments;
a correlation determination unit for determining a correlation between input and output based on an input data group for outputting the air temperature, the arbitrary-diameter globe temperature, and the relative humidity with respect to the specific thermal environments, and an output data group for outputting the standard-diameter globe temperature and the natural wet-bulb temperature corresponding thereto; and
a measurement calculation element for obtaining a standard-diameter globe temperature and a natural wet-bulb temperature from a real air temperature, an arbitrary-diameter globe temperature, a relative humidity under a real thermal environment, based on the correlation determined by the correlation determination unit.

29. The electronic WBGT meter according to claim 28,
wherein the correlation determination unit determines the correlation by learning the input and output data groups as learning data or
wherein the correlation determination unit determines the correlation by obtaining an approximate equation that is completed between the input and output data groups.

30. An electronic WBGT meter including a thermometer, an arbitrary-diameter globe temperature and a relative hygrometer, which comprising,
a first calculation unit for obtaining an arbitrary-diameter globe temperature of the electronic WBGT meter with respect to each of specific thermal environments, based on air temperatures, average radiation temperatures, and wind velocities under the specific thermal environments;
a second calculation unit for obtaining a standard-diameter globe temperature of the ISO-compliant WBGT meter with respect to each of the specific thermal environments, based on the air temperatures, the average radiation temperatures, and the wind velocities under the specific thermal environments;
a third calculation unit for obtaining a natural wet-bulb temperature of the ISO-compliant WBGT meter with respect to each of the specific thermal environments, based on the air temperatures, the average radiation temperatures, the wind velocities, and relative humidities under the specific thermal environments;
a correlation determination unit for determining a correlation between input and output based on an input data group for outputting the air temperature, the arbitrary-diameter globe temperature, and the relative humidity with respect to the specific thermal environments, and an output data group for outputting the standard-diameter globe temperature and the natural wet-bulb temperature corresponding thereto;
a measurement calculation element for obtaining a standard-diameter globe temperature and a natural wet-bulb temperature from a real air temperature, an arbitrary-diameter globe temperature, a relative humidity under a real thermal environment, based on the correlation determined by the correlation device; and
a WBGT calculation unit for calculating the WBGT index based on the standard-diameter globe temperature, the natural wet-bulb temperature, and the air temperature.

31. The electronic WBGT meter according to claim 30,
wherein the correlation determination unit determines the correlation by learning the input and output data groups as learning data or
wherein the correlation determination unit determines the correlation by obtaining an approximate equation that is completed between the input and output data groups.

32. An electronic WBGT meter including a thermometer, an arbitrary-diameter globe thermometer, and a relative humidity hygrometer, which comprising,
a measurement calculation element storing a correlation between data groups of the electronic WBGT meter and data groups of an ISO-compliant WBGT meter, inputting a real air temperature, an arbitrary-diameter globe temperature and a relative humidity under a real thermal environment; and obtaining a standard-diameter globe temperature and a natural wet-bulb temperature of the ISO-compliant WBGT meter,
wherein,
each of the data groups of the electronic WBGT meter including an arbitrary-diameter globe temperature of the electronic WBGT meter, an air temperature, and a relative humidity obtained in respect with each of specific thermal environments based on air temperatures, average radiation temperatures, and wind velocities under the specific thermal environments,
each of the data groups of the ISO-compliant WBGT meter including a standard-diameter globe temperature of the ISO-compliant WBGT meter obtained with respect to each of the specific thermal environments based on the air temperatures, the average radiation temperatures and the wind velocities under the specific thermal environments, and a natural wet-bulb temperature obtained with respect to each of the specific thermal environments based on the air temperatures, the average radiation temperatures, the wind velocities, and relative humidities under the specific thermal environments.

33. The electronic WBGT meter according to claim 32, further comprising,
a correlation determination unit determines the correlation by learning the input and output data groups or
a correlation determination unit determines the correlation by obtaining an approximate equation that is completed between the input and output data groups.

34. The electronic WBGT meter including a thermometer, an arbitrary-diameter globe thermometer, and a relative humidity hygrometer, which comprising,
a measurement calculation element storing a correlation between data groups of the electronic WBGT meter and data groups of an ISO-compliant WBGT meter, inputting a real air temperature, an arbitrary-diameter globe temperature and a relative humidity under a real thermal environment; and obtaining a standard-diameter globe temperature and a natural wet-bulb temperature of the ISO-compliant WBGT meter, wherein each of the data groups of the electronic WBGT meter including an arbitrary-diameter globe temperature of the electronic WBGT meter, an air temperature, and a relative humidity obtained in respect with each of specific thermal environments based on air temperatures, average radiation temperatures, and wind velocities under the specific thermal environments; and each of the data groups of the ISO-compliant WBGT meter including a standard-diameter globe temperature of the ISO-compliant WBGT meter obtained with respect to each of the specific thermal environments based on the air temperatures, the average radiation temperatures and the wind velocities under the specific thermal environments, and a natural wet-bulb temperature obtained with respect to each of the specific thermal environments based on the air temperatures, the average radiation temperatures, the wind velocities, and relative humidities under the specific thermal environments; and
a WBGT calculation unit for calculating an WBGT index based on the standard-diameter globe temperature, the natural wet-bulb temperature, and the air temperature outputted from the measurement calculation element.

35. The electronic WBGT meter according to claim 34, comprising,
a correlation determination unit determines the correlation by learning the input and output data groups or
a correlation determination unit determines the correlation by obtaining an approximate equation that is completed between the input and output data groups.

36. A measurement calculation element that stores a correlation between data groups of an electronic WBGT meter and data groups of an ISO-compliant WBGT meter, inputs a real air temperature, an arbitrary-diameter globe temperature and a relative humidity under a real thermal environment, and obtains a standard-diameter globe temperature and a natural wet-bulb temperature of the ISO-compliant WBGT meter,
wherein each of the data groups of the electronic WBGT meter including an arbitrary-diameter globe temperature of the electronic WBGT meter, an air temperature, and a relative humidity obtained in respect with each of the specific thermal environments based on air temperatures, average radiation temperatures, and wind velocities under the specific thermal environments, and
each of the data groups of the ISO-compliant WBGT meter including a standard-diameter globe temperature of the ISO-compliant WBGT meter obtained with respect to each of the specific thermal environments based on the air temperatures, the average radiation temperatures and the wind velocities under the specific thermal environments, and a natural wet-bulb temperature obtained with respect to each of the specific thermal environments based on the air temperatures, the average radiation temperatures, the wind velocities, and relative humidities under the specific thermal environments.

37. The measurement calculation element according to claim 36,
wherein the correlation is determined by learning the data group of the electronic WBGT meter and the data group of the ISO-compliant WBGT meter or
wherein the correlation is determined by obtaining an approximate equation that is completed between the input and output data groups.
